(19) United States
(12) Patent Application Publication
(10) Pub. No.: US 2014/0214708 A1
(43) Pub. Date: Jul. 31, 2014

(54) Community Oriented Job Hub For Increasing Efficiency In Hiring Processes

(71) Applicants: Ghazenfer Mansoor, Sterling, VA (US); Lawrence Au, Vienna, VA (US)

(72) Inventors: Ghazenfer Mansoor, Sterling, VA (US); Lawrence Au, Vienna, VA (US)

(21) Appl. No.: 13/750,740

(22) Filed: Jan. 25, 2013

(51) Int. Cl. G06Q 10/10

(52) U.S. Cl. CPC G06Q 10/1053
USPC 705/321

(57) ABSTRACT

A community oriented job application and hiring hub, to leverage the trust and transparency created by community charters and memberships, to share and review the potential job to job applicant matching data with improved emphasis on quality control of hiring processes and efficiency of hiring processes, using advanced computer technology to connect communities to other communities, and to hiring and sponsoring companies.

### BACKGROUND OF THE INVENTION

In current economic practices, recruiters pay to post jobs and gain access to applicants, and so this revenue has led to computer automation businesses, created to serve recruiters as clients. However, since job applicants do not pay into these automation systems, job applicants are treated as data, not clients, and receive few if any automation benefits. The disparity in payments, paid into this current system, which holds recruiters and companies in high regard, and takes their money, but disregards the needs and economic value of applicants, and ignores their money, as well as the value of their skills, thus causes a severe impedance mismatch, blocking the flow of valuable information in this current system, by stifling automation and efficiency with an overwhelming and unwarranted emphasis on serving the unilateral needs of recruiters and companies, while substantially ignoring, at great economic peril, the economic value of labor skills, held by individual people, accrued by them, in the global economy over billions of man-years of labor.

At the same time, the rise of the Internet, lowering the cost of collaboration and networking, has enabled many new expertise-oriented communities to arise. The rapid rise of these communities, such as regional meet-up groups gathered around expertise such as mobile app development skills, fills a void created by long, isolated, competitive work-hours, where workers can commiserate and share expertise and insights which, while truthful and economically valuable, are frankly unwelcome or impolitic within the workplace. By assuming that workers as commodities, companies belie the true issues in productivity, which are must be overcome by changes in business implementation tactics. In today's fast moving businesses, no commodity-oriented decision process can predict such changes, to the point where neither commodity job descriptions nor commodity resumes adequately address the hiring decisions involved, leaving personal interviews and reference checks to carry the bulk of the workload of hiring processes.

The information flow impedance mismatch resulting from these lopsided practices results in automation that does not track an applicant's work nor give adequate feedback that applicants need about their job applications, even though, in order to efficiently present themselves to recruiters , applicants must have timely details about hiring needs, which often fluctuate on a monthly basis.

This impedance mismatch in current hiring systems inherently reduces the level of understanding between job applicants and recruiters, further reducing the efficiency of hiring processes. For example, lack of automation for job application (not recruiter) workflow inherently reduces the data available for making informed decisions, for pools of applicants. by salary and working conditions expectations, which in turn reduces the ability of hiring managers to make informed offers. Furthermore, all this lack of understanding creates a lack of trust in which makes hiring processes inherently slow and error prone.

The current economy also creates hurdles to hiring by posting jobs in thousands of job boards with different formats for submitting applications, forcing applicants to redo their resumes and other credentials for each submission. This Balkanization of job boards supports individual unique goals of hiring organizations, to some degree, but by forcing job applicants to submit unnecessarily duplicative data, the current systems limit the pool of applicants available to these Balkanized job boards, and limits the number of companies which are available to each applicant.

In contrast to this sad picture, community-oriented associations have arisen, to truthfully talk about the true goals and best practices of expertise areas. These communities have skyrocketed in popularity in the past five years. For instance, the web site http://technology.meetup.com lists over 1,400 communities with over 450,000 members overall, for just Internet technologies. The inherent trust people place within communities, together with the collaboration that fosters, is a powerful untapped resource for such expertise practice areas, both for validating workers, the validating companies that would hire them, and validating the success of expertise goals to which those companies and workers devote themselves. The collective knowledge of this collaborative, peer-to-peer networking far exceeds the knowledge entrusted to current hiring systems, which remain woefully out-of-touch, out-of-date, and wasteful of global economic resources.

### SUMMARY OF THE INVENTION

The present invention creates a balanced central automation hub, for linking job applicants to recruiters, via community oriented associations, with novel transparency to reduce the barriers to understanding and trust which make hiring processes inefficient, and which increases the economic efficiency of community associations, both for referring companies to people and referring people to companies.

Leveraging trust and transparency which is inherent to community-oriented and often non-profit organizations focused upon specific expertise skills, the present invention cuts past the distrust and inflated, inaccurate claims which fill both job descriptions and resumes. For instance, http://technology-meetup.com lists ten groups each with over 3,000 members, such as the San Francisco based HTML5 group, and the New York City based MySQL group. If an employer were looking to hire in either of these expertise areas, there is no better place to look for vetted applicants than these communities. At the same time, the three thousand members of these communities have direct access to fellow members who work for nearly every major company in the country, and are able to advise each other on the relative merits working for various companies.

The present invention enable a community-oriented hiring hub, leveraging trust and transparency among community members to create a community brand which works with multiple companies to efficiently match people to jobs. A community-oriented hiring hub is superior to both company-oriented and individually-oriented hubs, since a communities are better on focusing upon the larger context of hiring issues, and the altruistic, socially responsible community charters are better suited to enforcing truth in advertising, so that both the false advertising by companies overselling jobs, and the false advertising by individuals misrepresenting their abilities, can be more efficiently suppressed. Communities are also better suited to controlling hiring hubs, than companies or individuals, community organization goals, though biased towards specific skill sets, are still more open for discussion and more relevant to economic productivity than either the profit goals of companies or the personal career goals of individuals. Within the global economy, discourse within community expertise organizations are the closest we have to fair trade in productivity related knowledge.

Multiple practical concerns currently prevent communities from assuming a lead road in all hiring. Traditionally, companies treat hiring as a cost of business, and try to minimized this cost, as a tradeoff, where too much minimization of up-front costs can unfortunately incur the enormous cost of hiring the wrong people. Since pitfalls of this tradeoff are rarely studied and poorly understood, traditionally companies pay for formulaic, but inefficient practices, such hiring recruiters, head-hunters, and paying for access to traditional job boards. The automation systems created for these traditional recruiters, head-hunters and job boards all have a vested interest in preserving systemic inefficiencies, rather than risk the obsolescence that comes with client-base erosion.

In contrast, a community-based hiring automation system inherently has a more modest, but socially beneficial motive. Rather than treating the hiring process as a pure, economically driven, market arbitration process, a community-oriented hiring system must put the social goals and social needs of community members before economic interests, and in the process, build upon values that are more durable and creative than short-term profit motives. To automatically support these values, a community-based hiring automation system must stay on-message and transparently pro-bono as possible, in each and every user interface, web page, mobile application, and email interface, while automatically building community memberships by bridging over the differences in knowledge or power that cause distrust and prevent strangers from collaborating with other.

The present invention teaches that such bridges can be created by web page widgets, easily installed by a single line of HTML code, which bring shared data, such as job board listings and job applicant data listings, to view within dozens of company websites, community websites, and even blogs. To enable so many different sites to carry these all marketing brand needs of disparate companies and disparate expertise organizations must be harmonized. These brand needs can be harmonized using camouflage to insert automation user experience features, enabling a single hub to appear in multiple brands without apparent conflict.

The present invention using a camouflage web page widget to federate job boards from individual recruiter and company web pages, while preserving the look and feel and branding qualities of these web pages, the present invention reduces the Balkanization of job boards. This web page widget connects to a central hiring automation facility over the Internet, with dashboards to make interactions between recruiters and job applicants more transparent.

To further harmonize across disparate companies and communities, the present invention goes beneath the surface of graphic appearances, to harmonize the syntax of text within the context of individual websites. To serve specific audiences, websites often tailor their content, changing the phrasing and presentation of ideas, to make their site more approachable and engaging. It is jarring to introduce content, in the form of job applicant listings or job listings, without also filtering and translating these listing to conform with specific audience needs.

Building upon recent advances in artificial intelligence and natural language processing, the present invention automatically conforms job applicant listings or job listings to preset community syntactic standards.

With these mechanisms for enabling a greater variety of audiences to trust and understand job applicant listings and job listings, the present invention enables communities to serve a central role in hiring processes, displacing companies from the central role they would otherwise play, thus bypassing the disadvantages of companies who are otherwise thrust into this role. At the same time, the present invention opens the door to more productive cash flows into hiring automation hubs, by serving communities and even individuals on a priority basis, over companies. By charging communities for listing services, those services can more quickly be tailored, through the mechanisms outline above, to increase the influence those communities have. At the same time, by charging individuals for community benefits, community benefits can be more quickly tailored for individual needs. As a result, by enabling and encouraging grass-roots cash flows from individuals and communities, which often have social networking orientations with non-profit and altruistic goals, to affect a global hiring hub, that global hiring hub can evolve more quickly to deliver higher quality, higher efficiency hiring automation, than competing hiring hubs which emphasize the needs of companies, whose competitive profit and greed motives generally require secrecy and thus prevent the sharing of information that would make hiring processes more efficient.

### BRIEF DESCRIPTION OF THE DRAWINGS

FIG. 1 Scope Of Recruiter Tracking System Automation

FIG. 2 Scope Of Symmetric Hiring Systems Automation

FIG. 3 Recruiter Tracking System Automation WorkFlow

FIG. 4 Symmetric Hiring Systems Automation Workflow

FIG. 5 Drop-in Widget

FIG. 6 Open Widget

FIG. 7 Camouflage Widget

FIG. 8 Camouflage Dashboard

FIG. 9 Camouflage Preview

FIG. 10 Automated Translation Of Employment Terminology

FIG. 11 Automated Quality Control Of Employment Requirement Terminology

FIG. 12 Quality Control Server Analysis Of Job Requirements

FIG. 13 Quality Control Server Analysis Of Job Skills

FIG. 14 Job Requirement Translation Map Technology

FIG. 15 Job Skill Translation Map Technology

FIG. 16 Company Relationship Management Tracking

FIG. 17 Candidate Relationship Management Tracking

FIG. 18 Quality Community Hiring Hub

### DETAILED DESCRIPTION OF THE INVENTION

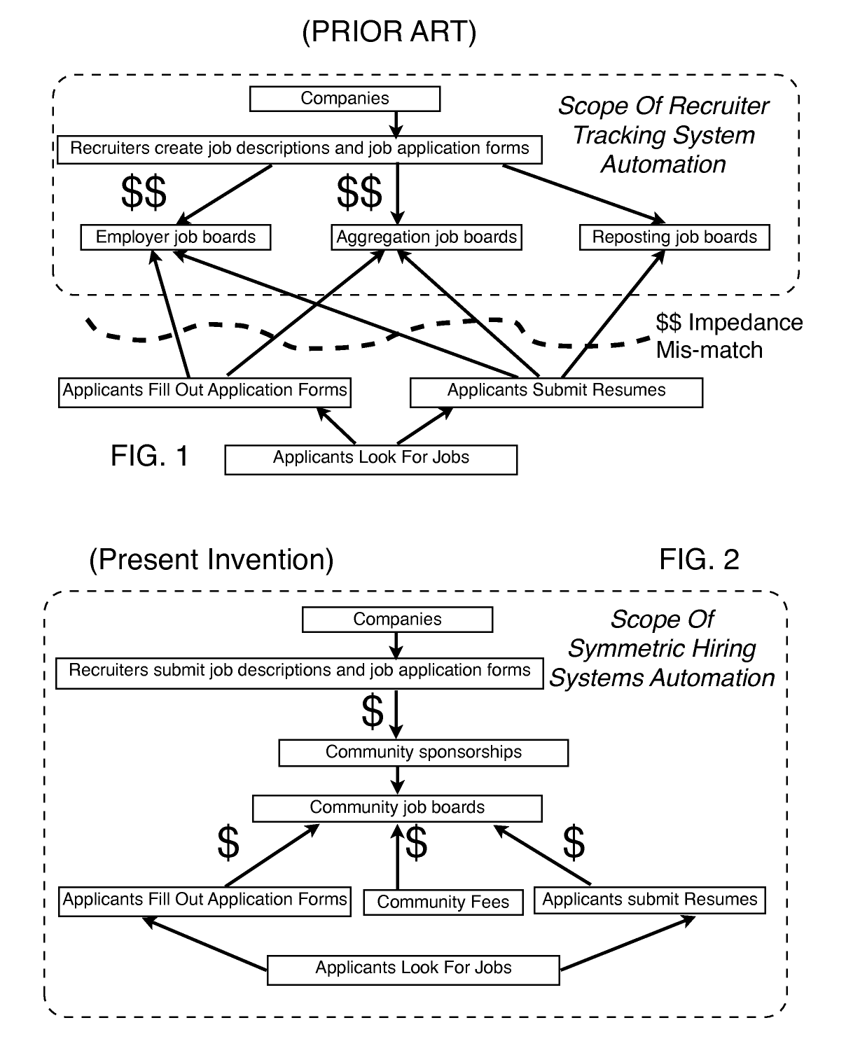

The current practices in hiring hub automation systems are shown by the method flowchart of FIG. 1. Within current practices, companies or recruiters working for companies create job descriptions, then pay to list these job descriptions and job application forms on Employer Job Board automation systems, or pay to list these job descriptions and job application forms on Aggregation Job Board automation systems. These automation systems generally charge a per-posting fee, or charge for a package of posting privileges, extending either over a fixed span of time or a fixed number of posts.

Talent, in the form of job applicants, enters these automation systems as filled out job application form content, and resumes. Typically, this talent pays nothing to submit content, but puts in a great deal of sweat labor to tailor resumes and answer questions in job application forms. Despite the high personal cost of this sweat labor, by not paying into automation systems, typical automation systems treat talent as a dumb commodity and give little or no feedback to talent on their likely prospects or strengths and weaknesses relative to the jobs they apply for. Consequently, there is a dramatic impedance mismatch, shown by the wavy dashed line of FIG. 1, in the information flow between companies and talent, where companies keep talent uninformed and unenlightened about their job prospects, and talent keeps companies guessing as to their true abilities, by exaggerating skills listed in their resumes and application forms, until the distrust created by this impedance mismatch is resolved during laborious interviews and reference checks. The four dollars signs, two for posting to Employer job boards and two for posting to Aggregation job boards, show the approximate balance of investment into prior art hiring automation systems, which prejudices hiring automation systems towards the agendas of companies. Since these agendas include greed, profit motives, competitive secrecy, there inherently intentional lack of transparency and efficiency in current hiring systems.

In contrast, FIG. 2 shows the method of the present invention, in which communities hold the central control over hiring automation systems. Instead of companies determining the structure, method and standards of hiring systems, communities chartered for discussing specific skills or altruistic social goals determine the structure, method and standards of hiring systems. As a result, while still accepting posting payments in the form of community sponsorships, the present invention enables Community Job Boards to accept most resources, including money, from community members, in the form of community fees and submission fees for resumes and filled out application forms. Since communities, whose profit motives are subordinated to higher goals thus control the process, communities are inherently easier to trust, as filters that ensure that only quality content from members reaches companies. Thus companies will pay more for access to this information than they will pay for access to traditional job boards and aggregation job boards. At the same time, since community-approved job application form content can automatically be routed to multiple companies, community members save sweat labor time by filling out only one job application form, and submitting one resume, to apply for jobs in multiple companies. As a result, community members are happy to pay application fees to their communities for this community service.

Instead of profit-oriented recruiting agencies managing the job markets, communities can thus manage the job market for specific skills and social interest groups. Since communities are often operated on a non-profit, egalitarian basis, without excluding members, except for misconduct, communities can far outperform recruiting agencies in areas of technical expertise, trust, and breadth of contacts, while at the same time, minimizing costs by relying upon community members to police and maintain the quality of community focus and expertise. As FIG. 2 shows, in the balance of dollar signs above and below the Community job boards, communities are a more natural hub, free of the greedy biases of payments into automation systems which causes the information flow impedance mismatch of FIG. 1. Money flowing into communities is visible to other community members, and typically, in non-profit statements of account, so there is greater transparency to money flows through communities, than in payments to individual recruiters and other for-profit entities typically central to prior art money flows of FIG. 1.

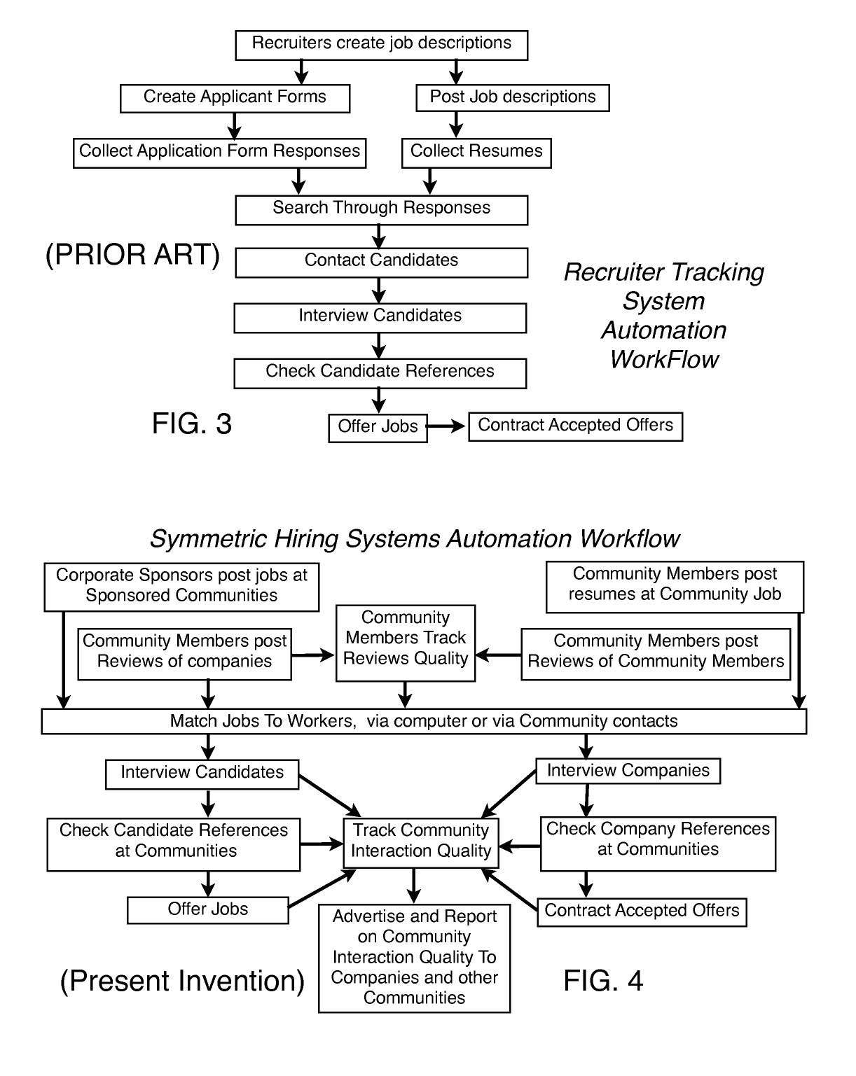

Communities promoting specific social ideals, such as equal rights or religious freedom, will find eager corporate sponsors from companies eager to support these social ideals, and community-oriented job hubs are an ideal way to promote and develop these relationships. The transition of the United States from an ethnically monolithic society to a society dominated by many minorities further increases the need for community-based and community oriented job hobs, where immigrants each from a different ethnicity can band together to promote their contributions to society, in a fair and egalitarian automated access to jobs. The pan-community job hub of the present invention in turn builds bridges between disparate minorities by explaining, in respectful, harmonious and through translation, also adaptive community-based user interfaces, to offer skills jobs across multiple public job web sites. To teach how these adaptive community based-user interfaces make hiring process more transparent and efficient, the PRIOR ART flowchart of FIG. 3 contrasts with the PRESENT INVENTION flowchart of FIG. 4.

In FIG. 3, traditional, greed-biased company-driven hiring automation processes are outlined. Using a top-down, corporate profit motive to orchestrate and prioritize automation methods, FIG. 3 shows a method sequence in which all decision points are controlled by companies, and all information is conveyed by distrustful parties on a just-in-time, need-to-know basis. There are negligible automatic quality control information flows in this process, because lack of trust prevents quality controls, except for the manual, labor intensive steps of interviewing candidates and checking candidate references. Even so, greed-driven secrecy and distrustful privacy concerns prevent results of interviews and reference checks from being shared, thus absolutely stifling the small amount of quality control data FIG. 3 generates.

Because of the lack of quality controls, low job posting and low resume quality are submitted to the processing of FIG. 3, causing the labor intensive and costly Interview and Candidate References checking tasks to be even more costly, and even slower.

FIG. 4, in contrast, capitalizes on the higher degree of trust surrounding communities, and the greater willingness to share information created by that trust. By allowing community members to post reviews on companies, as well as reviews on the quality of work done by community members, submitted job descriptions and submitted resumes are vetted in a way similar to consumer generated reviews, with the added peer pressure created by the fact that reviewers within a community are highly likely to meet each other socially, so the thoughtfulness and respectfulness of reviews will tend to be much higher than the anonymous reviews which cover commercial product consumer generated content. The quality control process of Community Members Track Reviews Quality shows that Reviews, as well as post jobs and resumes, are incorporated into either manual or automated matching processes, under the oversight of Community members, to ensure a higher quality of matching than the Search Through Responses process of FIG. 3.

In FIG. 4, further along hiring processes, the present invention tracks the quality of community hiring interactions with companies or sponsor corporations. Since communities will vary in their abilities to provide quality labor sources to companies, companies will be interested to know which communities are most likely to provide high quality labor sources. These quality metrics are used to prioritize the display of candidate matches to posted jobs, and to advise companies about which communities to sponsor. The present invention can also provide similar quality metrics about companies to community members who are applying for jobs. Average salaries, time to closing employment contracts, quality of company references, number of open positions can all be shared among community members or even between trusted community organizations, in the Track Community Interaction Quality process. Unlike LinkedIn and Facebook, trusted communities are not organized for the sake of networking all people on the planet, but only networking people with shared interests, values and goals, so the personal information which would not be shared on LinkedIn and Facebook could actually be shared in present invention.

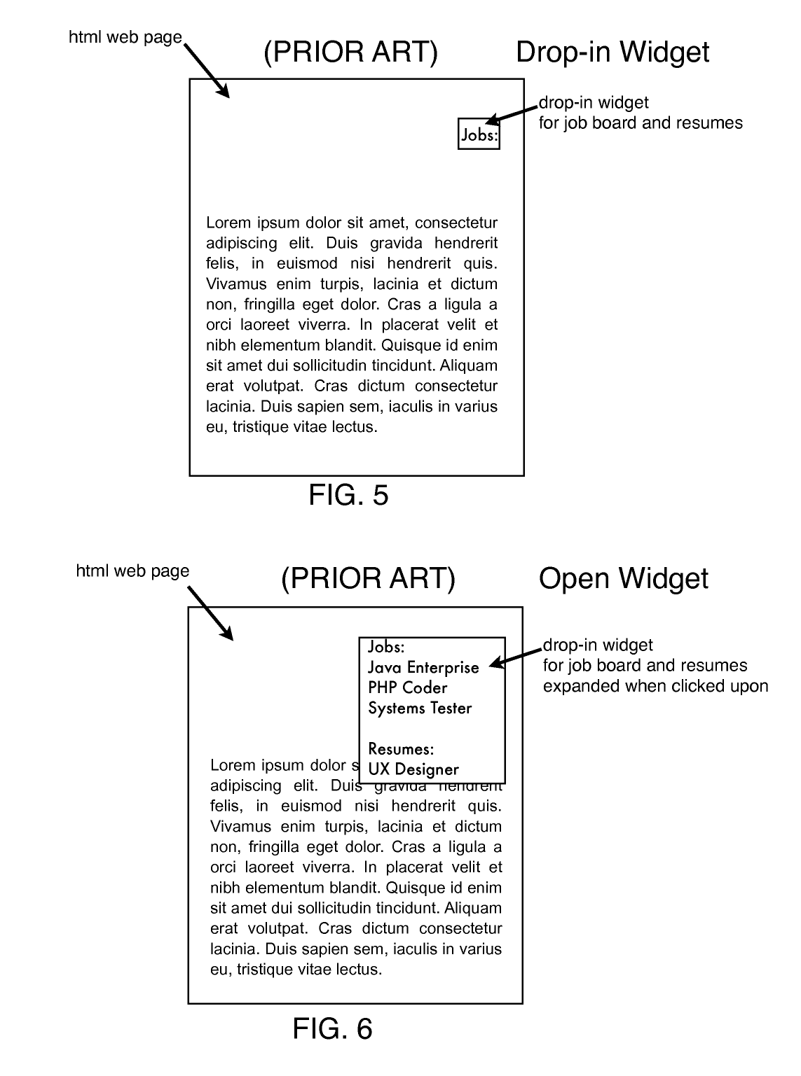

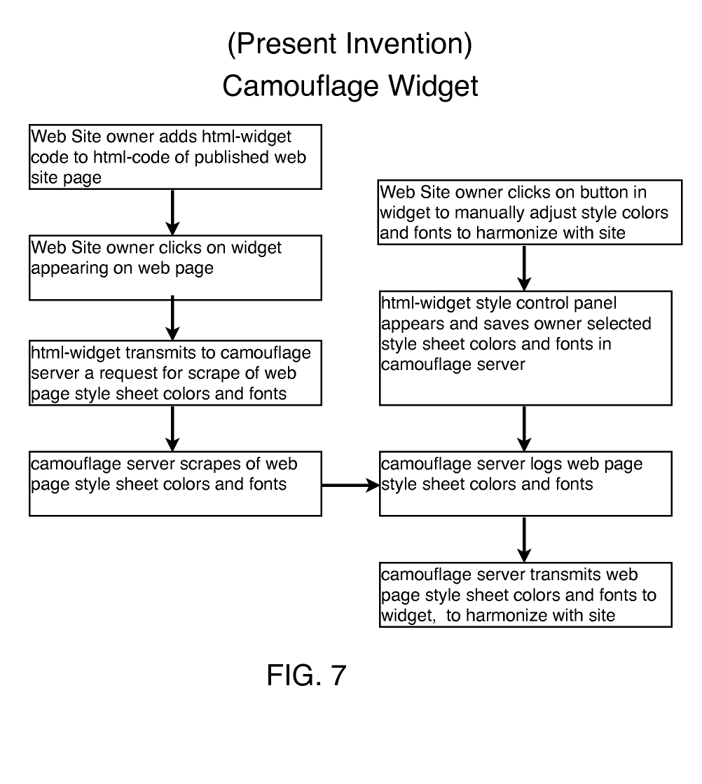

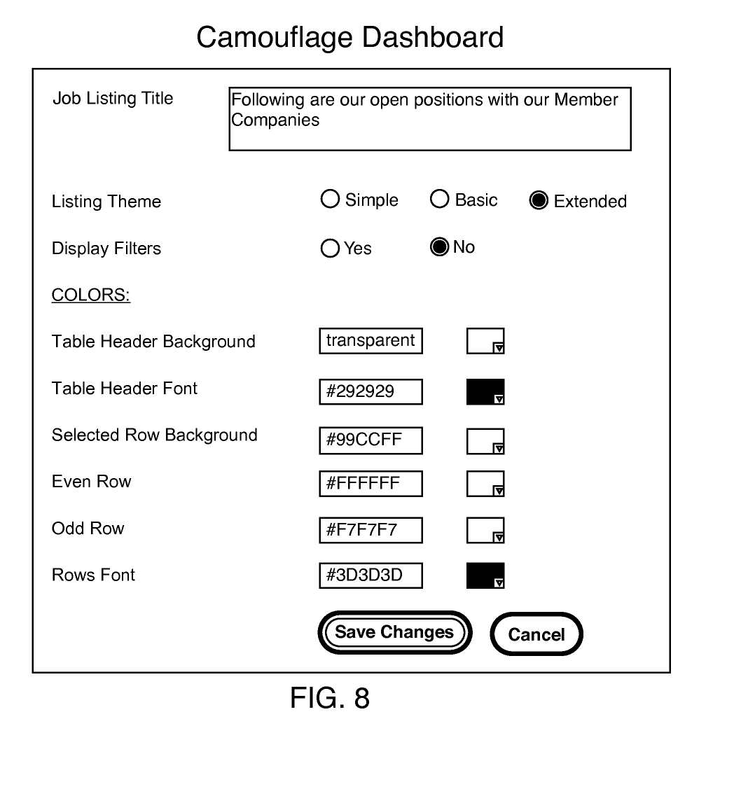

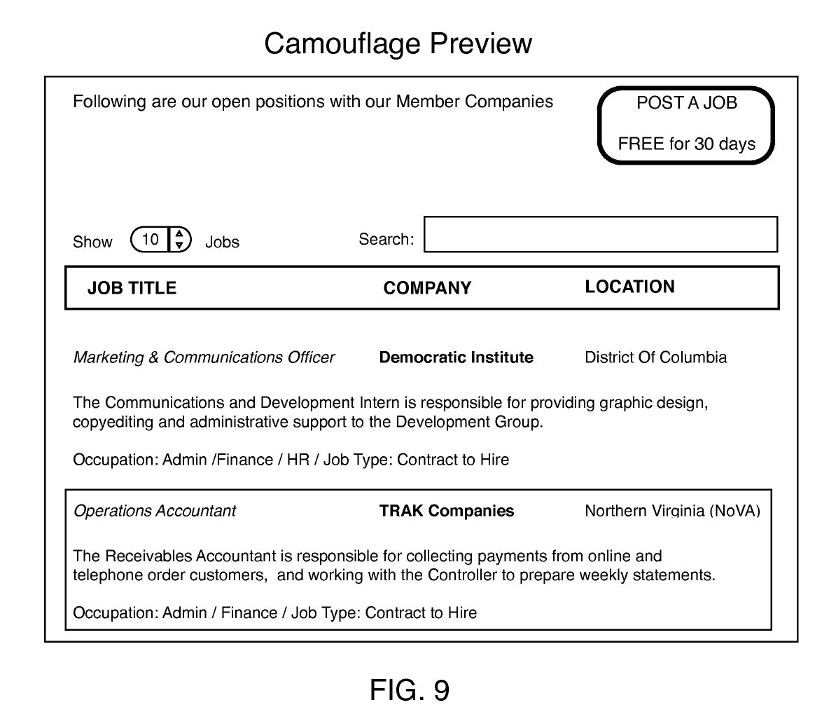

To enable this sharing of information, across multiple web sites, the present invention teaches the use of camouflage widgets to cost-effectively graft access to job boards and resumes onto current web sites, consistently with their current branding graphical styles. FIG. 5 shows prior art of drop-in single-line of HTML code widgets, which can be added to existing web site easily, by adding a single line of HTML code referencing a server publishing job board listings and resumes. Although easy to add to existing web sites, the typical font and graphic style, as shown in FIG. 6, rarely if ever resembles the host web site, so that when clicked upon to open up listings for display, a jarring discontinuity in font, color and wording tends to erupt, reducing trust and confidence in the brand shown to the users of the site. Especially when showing commercially significant data such as job listings and resumes, trust and confidence are highly important to preserve, so the present invention automatically camouflages widgets to match their surrounding web sites. FIG. 7 shows a method for matching colors and font styles of web pages, directly after a web site owner has added a widget to the web site. The widget sends a message to the server of the widget, to scrape the web site for style sheet related information about fonts and colors used. Then, when a widget in the web page is first clicked, by the web site owner, the server of the widget shows a dashboard and preview of the automatically matched colors and fonts, as well as controls to fine-tune those settings. This manual override step can even be skipped, so that camouflage widgets are matched to web site graphics without human intervention. FIG. 8 shows an example of a camouflage widget dashboard for fine-tuning colors and fonts. FIG. 9 shows an example of a preview of a widget, as controlled by the dashboard of FIG. 8.

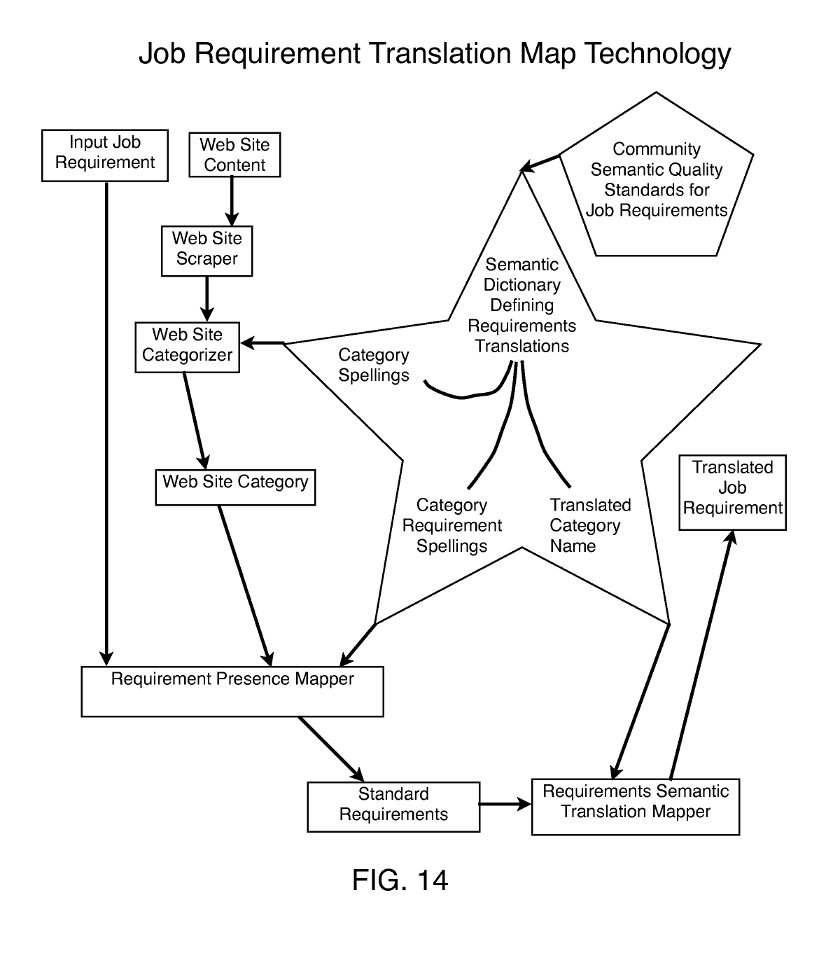

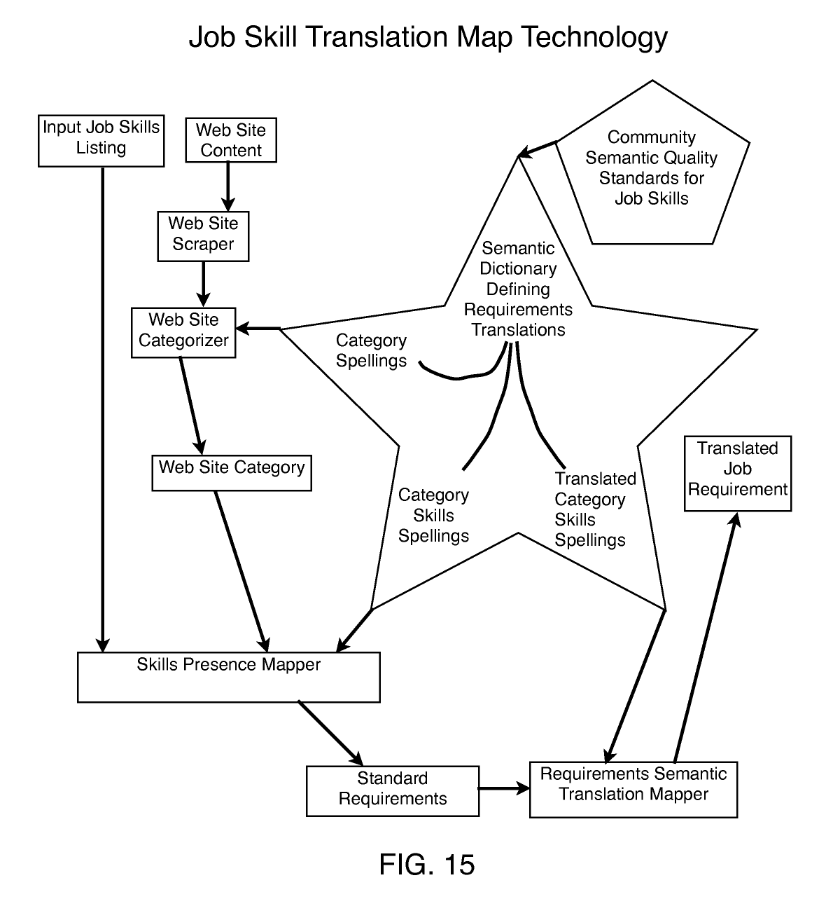

Further matching contextual brand expectations, for increasing user trust and confidence in the job descriptions and job application content such as resumes, the present invention also translates the meaning of job skills and responsibilities to be more accessible and easily understood. For instance, an encouraging community for novices, such as Girl Develop It, a New York based meetup with over three thousand members, might want to translate the meaning of job responsibilities to be easily understood by people interested in making a career change. A more narrowly technical community such as the San Francisco Javascript Meetup with over 4000 members might want to translate the meaning of job responsibilities into hacker-friendly phrasing, to convince hard-core hackers to take a look jobs that otherwise might seem too boring. Translating typical job descriptions into more florid or understandable text can be manually done by community members, or automatically the Job Requirement Translation Map Technology method shown in FIG. 14. Using available artificial intelligence semantic parsing and translation software, the present invention can categorize web sites, into categories such novice or expert, and then map individual job requirements, through a semantic dictionary, into more accessible and easily understood phrasing, following guidelines selected and implemented by community members. Similarly, the job skills listed in resumes and job application form content may be more accessible and better understood by companies and recruiters if translated into terminology that closely matches the way language is used by those companies and recruiters on their websites. FIG. 15 shows a Job Skill Translation Map Technology method which uses available artificial intelligence semantic parsing and translation software, to categorize web sites, into categories such novice or expert, or specific kinds of expertise, to translate specific skill found in resumes and filled job application content, into appropriate terminology. The translations performed by the methods of FIG. 14 and FIG. 15 may also cover translation from language to language, as needed, such as Italian to English or Urdu or Japanese or Chinese, as needed by various communities.

The present invention not only can use community defined standards to translate content into more understandable and accessible terminology, but also to control the semantic quality of text for community standards. For instance, the New York based Girl Develop It meetup may wish to eliminate any discouraging text about jobs or jobs skills, to keep the encouraging tone of their site at a consistent level. Similarly, any reviews of companies or especially of other members, written by members, should be encouraging in tone.

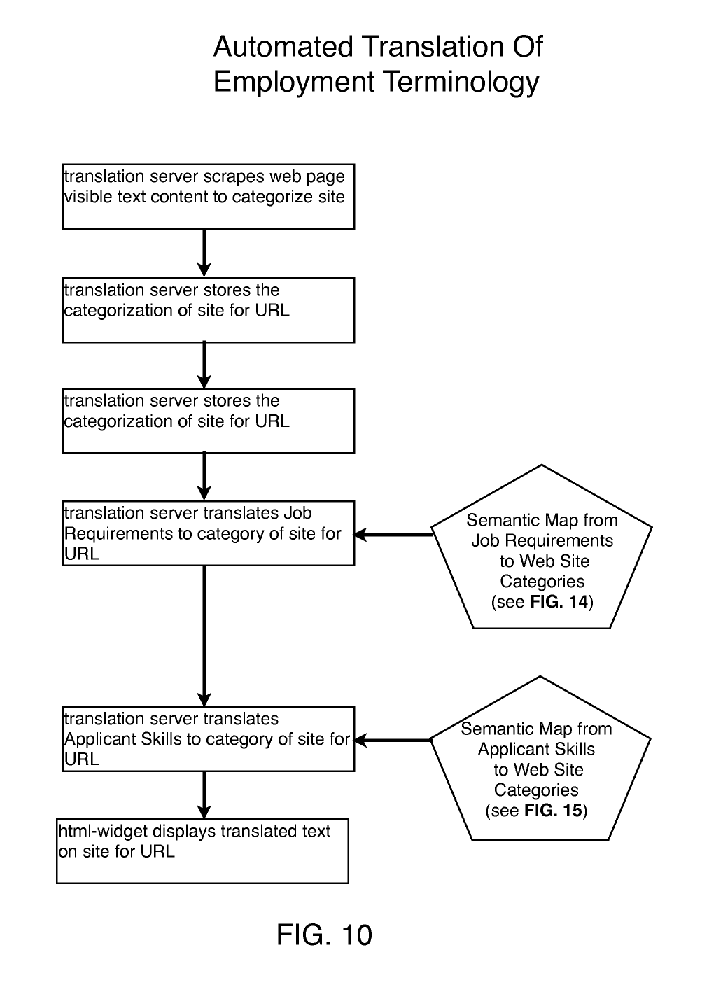

Thus community content on the web and mobile devices must be automatically moderated, to some degree, to ensure that content generated by community members and affiliated organizations, such as sponsors, is appropriate and encouraging in tone and authenticity. FIG. 10 shows a method for passing such content through automated scraping and categorization, for semantic mapping and translation into appropriate, encouraging and authentically helpful content wording. The actual methods of translations were described above and shown in FIG. 14 and FIG. 15.

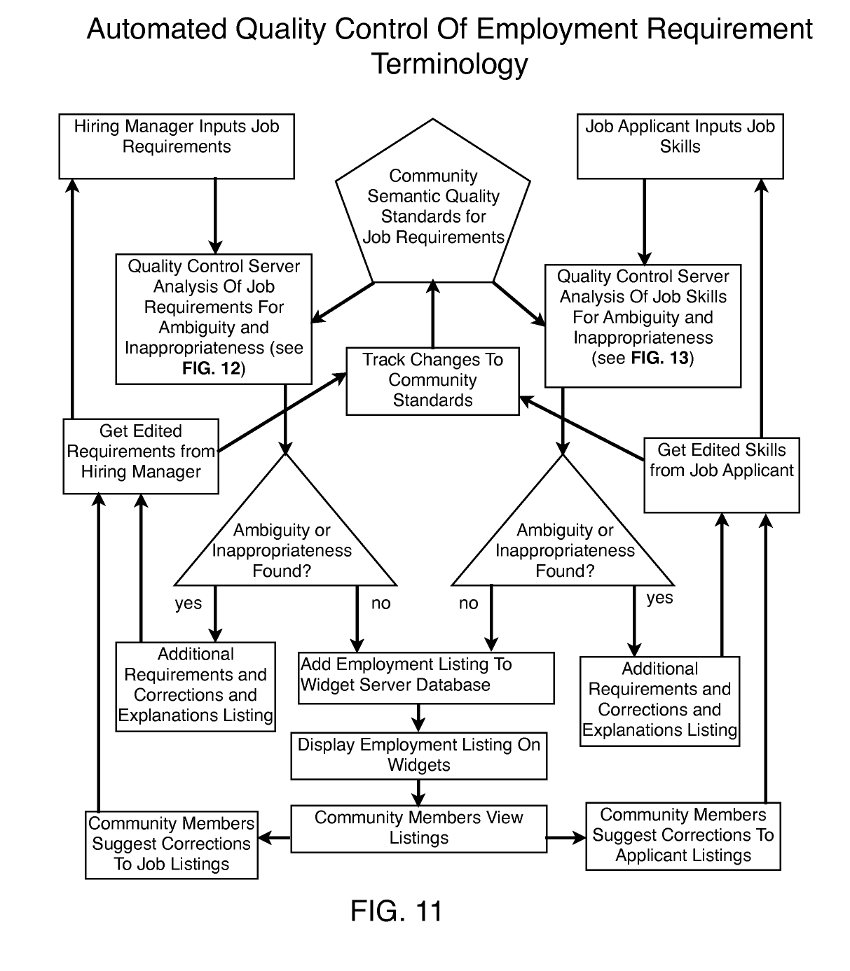

FIG. 11 shows a more elaborate, inclusive and accurate method to moderate content than FIG. 10. Unlike FIG. 10, steps to report on specific irregularities in wording and appropriateness are included, to automatically encourage authors of such content to make corrections, conforming content to minimal quality standards.

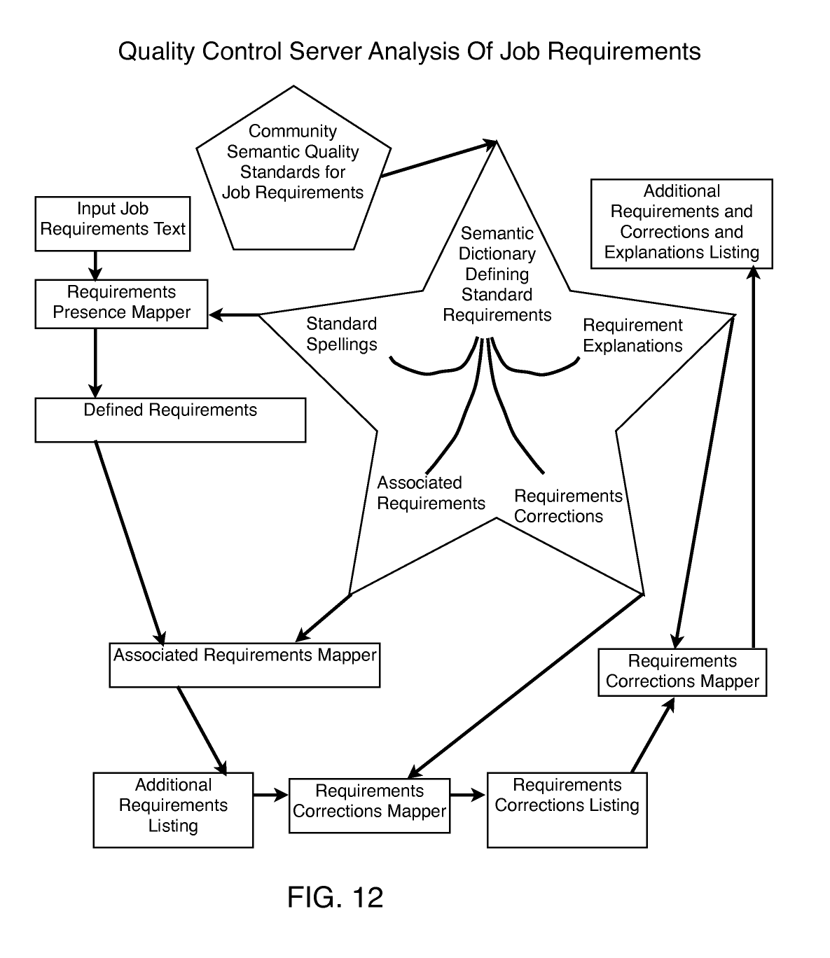

By assessing content quality, either manually or using artificial intelligence, the present invention routes problematic content back to authors for revision, delaying publication until content meets community set standards for quality, appropriateness and authenticity. As shown in FIG. 11, this routing of problematic content can be done both for job descriptions and job application content, or even reviews of companies and other community members, as mentioned above. For automatically assessing job description content quality, FIG. 12 shows an artificial intelligence method using a semantic dictionary, defined by community members, to map known standard job descriptions to associated job requirements, for clarity and completeness, with any omissions and deviations from standards reported as necessary corrections, requested of the job description authors. In this way, communities can make sure that only jobs which are acceptable and reasonable to the community can be listed in the community job boards, to increase community membership confidence and trust in the community web site.

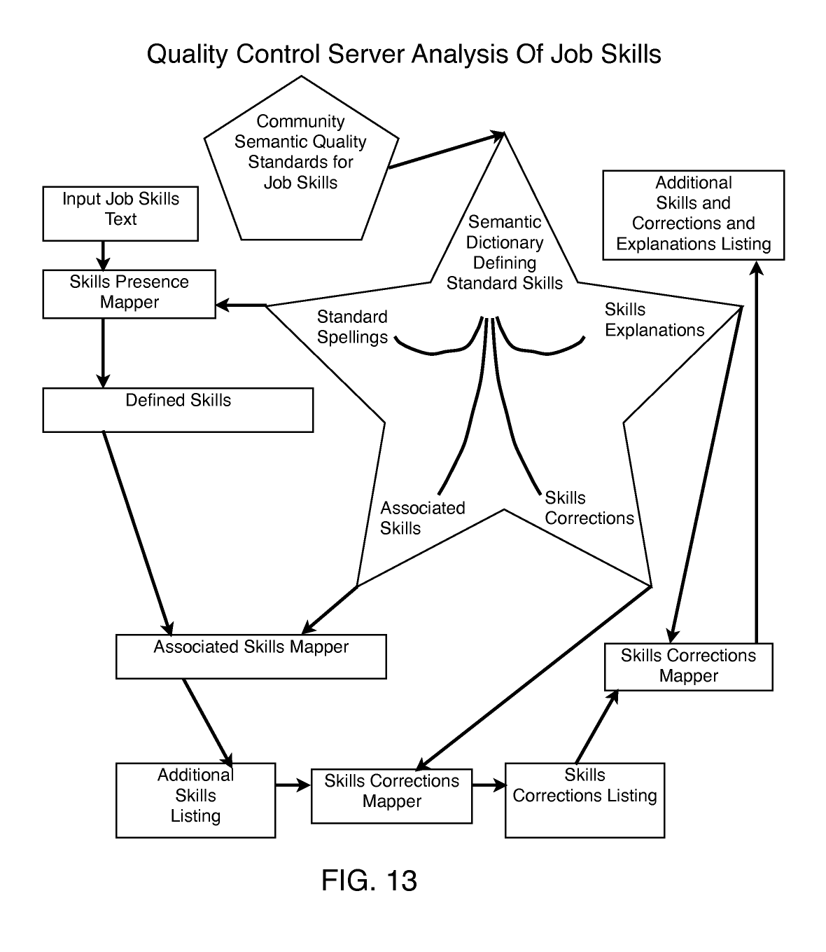

Similarly, for automatically assessing job applicant content, FIG. 13 shows an artificial intelligence method, using a semantic dictionary, defined by community members, to map known acceptable skill descriptions to associated skills, for clarity and completeness, with any omission and deviations from standards reported as necessary corrections, requested of the job application authors. In this way, communities can make sure that its members represent their community in a positive and convincing display of expertise, to increase confidence and trust in the community web site, and attract higher levels of sponsorship from companies and corporations.

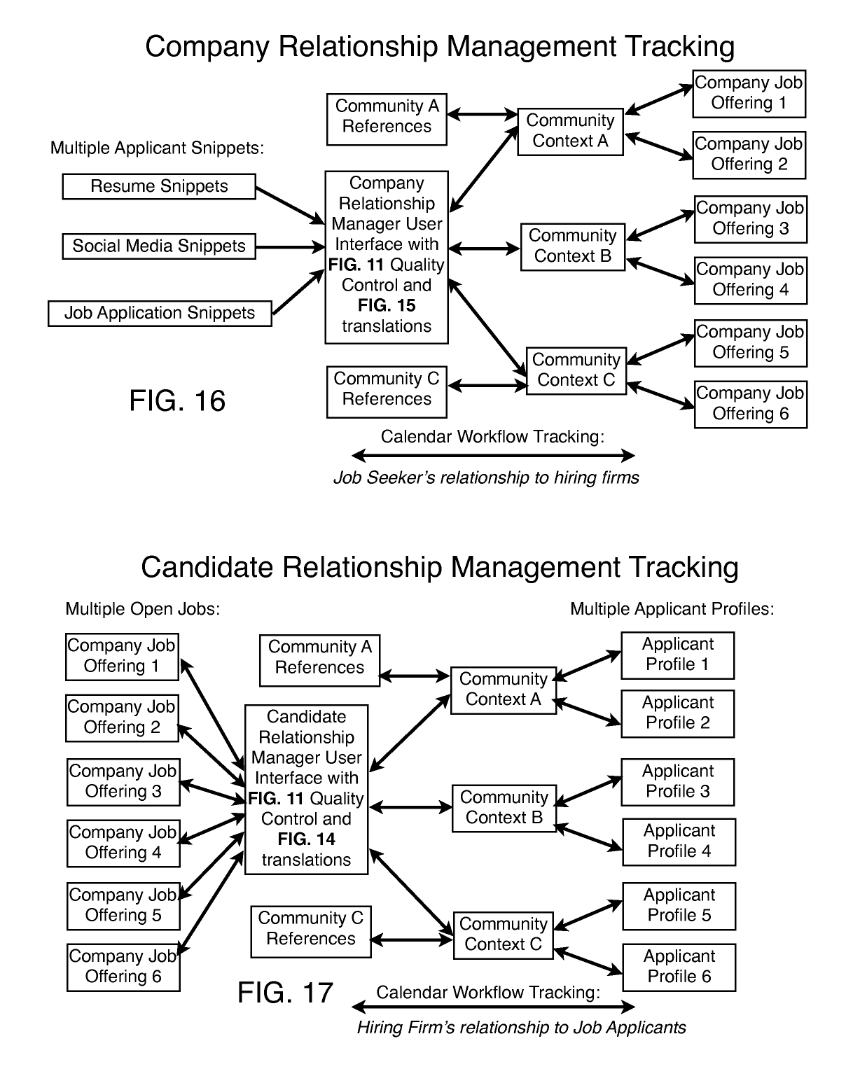

Since the FIG. 2 monetization method of the present invention architects user experience objectives around the role of communities, which are economically more central and less biased than the role of companies and individuals, and central community content standards automatically moderated by the FIG. 11 method maintain higher quality content standards, for hiring workflow content, than prior art, the tracking, over time, of hiring workflows is easier and clearer, as seen through the lens of community contexts, than through traditional prior art hiring-workflow tracking-systems. For instance, in FIG. 16, a variety of content, such as resumes and social media content, as well as job application content, including essays, descriptive of applicants can be automatically translated by the method of FIG. 15, and moderated by the method of FIG. 11, then submitted to various Communities, and tracked community-by-community, tracking submissions to company job postings associated or affiliated with communities, with community members providing oversight and references, (shown as Community A References) on this application process, and with the Company Relationship Manager providing feedback to applicants on the workflow status of multiple community, multiple job applications. This tracking method can record notes about emails, phone conversations, texting, and interviews, as well as application form and resume content (not shown).

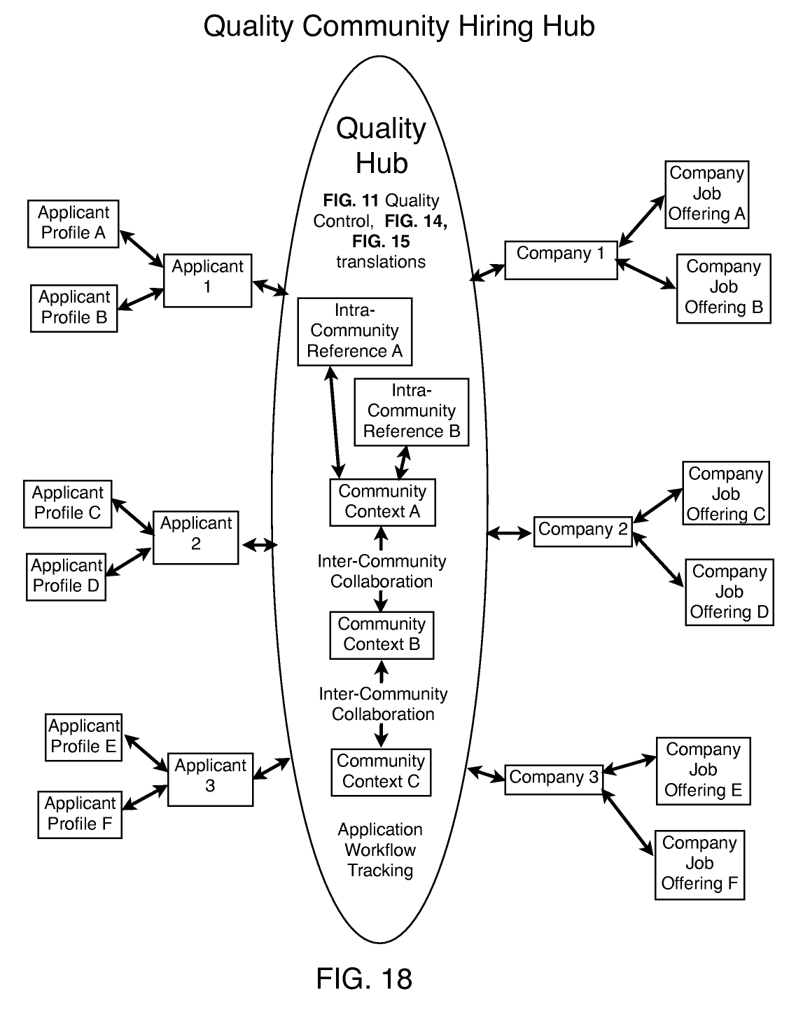

Similarly, in FIG. 17, a variety of company job openings can be automatically translated by the method of FIG. 14, and moderated by the method of FIG. 11, then posted at various Community job boards, (Community contexts), and when members of the respective communities apply for these jobs, the Candidate Relationship Manager provides feedback to hiring managers and recruiters, to track the process of applicants through company hiring workflows, including contacting Community References to applicants, such as Community References A and Community References B. This tracking method can record notes about emails, phone conversations, texting, and interviews, as well as application form and resume content (not shown).

Building a job hiring tracking system around community oriented content quality controls enables the methods of FIG. 16 and FIG. 17 to deliver higher quality and more efficient feedback to all participants in hiring processes. Combining the advantages of FIG. 16 and FIG. 18, into the Quality Community Hiring Hub of FIG. 18 shows how the quality control methods of FIG. 11, FIG. 14 and FIG. 15 enable hiring to be more efficient across multiple communities. By increasing the quality, transparency and credibility of content within hiring application workflows, the economic value of multiple communities can be fruitfully integrated into a single universal hiring hub for all types of jobs. Taking advantage of the fact that communities are less biased and more trustworthy arbiters of content standards than companies and individuals, and the fact that non-profit organizations are less biased and more trustworthy content standard bearers than for profit companies and individuals, the Quality Community Hiring Hub of FIG. 18 enables communities to more easily collaborate with each other, by sharing job postings, advice on workplace and careers opportunities, and sharing references and recommendations about community members, making the hiring process more friendly, encouraging and free from misunderstandings. Further, a single monolithic hiring hub enables all individuals companies to share a web portal or mobile application handling all their hiring and job application needs, thus gaining the network effect from sharing and collaboration across an entire economy.

We claim:

1) A computer implemented system and method for a central hiring information hub for matching people who are members of communities to job openings at companies, wherein companies compensate the communities or the central hiring information hub in exchange for access to listings of information about community members and skills found within communities,
and community members or communities compensate the central hiring information hub in exchange for access to information about job opening or companies,
wherein, for consistency of community brand reputations, a set of community standards automatically conforms or automatically controls publication of posted content which describes job listings or describes listings of people qualified for jobs.

2) The method of claim 1 wherein community members pay communities for resume submission rights or job application content submission rights.

3) the method of claim where descriptions of job postings and job applicants are automatically conformed to suit multiple standards of multiple communities across the Internet.

4) the method of claim 1 where descriptions of job postings and job applicants are automatically conformed to multiple semantic standards of multiple companies across the Internet.

5) the method of claim 1 where descriptions of jobs and job applicants are automatically translated to conform to community or company standards

6) the method of claim 1 wherein visual and graphical styles of a web page widget are automatically conformed to hosting web pages.

7) the method of claim 1 wherein the job applicant data communities with highest hiring activity or highest hiring satisfaction are sorted to the more easily viewed positions of listings.

8) the method of claim 1 wherein communities publish critiques written by community members about work done by other community members.

9) the method of claim 1 wherein a community oriented Company Relationship Manager User interface tracks job application workflows for community members.

10) the method of claim 1 wherein a community oriented Candidate Relationship Manager User Interface tracks job applicant workflows for companies.

11) the method of claim 1 wherein a single quality control hub asserts multiple community quality standards, enabling collaboration between communities and tracks job applications workflows across multiple communities, multiple companies and multiple community members.
